(19) United States
(12) Patent Application Publication
(10) Pub. No.: US 2024/0095569 A1
(43) Pub. Date: Mar. 21, 2024

(54) TECHNIQUES FOR MITIGATING RADIATION-INDUCED ERRORS IN QUANTUM PROCESSORS

(71) Applicant: Yale University, New Haven, CT (US)

(72) Inventors: Max Hays, New Haven, CT (US); Michel Devoret, New Haven, CT (US)

(73) Assignee: Yale University, New Haven, CT (US)

(21) Appl. No.: 18/465,433

(22) Filed: Sep. 12, 2023

Related U.S. Application Data
(60) Provisional application No. 63/406,054, filed on Sep. 13, 2022.

(51) Int. Cl. G06N 10/40

(52) U.S. Cl. CPC G06N 10/40

(57) ABSTRACT

Techniques are described for detecting when background radiation has impacted a qubit without the need for additional hardware. In particular, a quantum system may operate readout hardware to read the state of a qubit in addition to operating the readout hardware to detect when an impact has occurred. Readouts from impacted qubits can then be ignored during error correction, and those qubits reset for subsequent operations. In some cases, a readout resonator coupled to a qubit can be implemented as a readout resonator with a high kinetic inductance.

### CROSS-REFERENCE TO RELATED APPLICATIONS

The present application claims the benefit under 35 U.S.C. § 119(e) of U.S. Provisional Patent Application No. 63/406,054, filed Sep. 13, 2022, titled “Techniques for Mitigating Radiation-Induced Errors in Quantum Processors,” which is hereby incorporated by reference in its entirety.

### GOVERNMENT FUNDING

This invention was made with government support under W911NF-18-1-0020 awarded by the United States Army Research Office. The government has certain rights in the invention.

### BACKGROUND

Quantum information processing techniques perform computation by manipulating one or more quantum objects. These techniques are sometimes referred to as “quantum computing.” In order to perform computations, a quantum information processor utilizes quantum objects to reliably store and retrieve information. According to some quantum information processing approaches, a quantum analogue to the classical computing “bit” (being equal to 1 or 0) has been developed, which is referred to as a quantum bit, or “qubit.” A qubit can be composed of any quantum system that has two distinct states (which may be thought of as 1 and 0 states), but also has the special property that the system can be placed into quantum superpositions and thereby potentially exist in both of those states at once.

### SUMMARY

According to some aspects, a circuit quantum electrodynamics system is provided comprising a plurality of qubits, a plurality of readout resonators, wherein each qubit of the plurality of qubits is coupled to one of the plurality of readout resonators, at least one controller, and at least one computer readable medium storing instructions that, when executed by the at least one controller, perform a method comprising receiving a readout signal from each of the plurality of readout resonators, thereby receiving a plurality of readout signals, and detecting background radiation incident on one or more qubits of the plurality of qubits based on the plurality of readout signals and based on the relative spatial locations of the plurality of qubits.

According to some aspects, a circuit quantum electrodynamics system is provided comprising a plurality of qubits, a plurality of high kinetic inductance readout resonators, wherein each qubit of the plurality of qubits is coupled to one of the plurality of readout resonators, at least one controller, and at least one computer readable medium storing instructions that, when executed by the at least one controller, perform a method comprising receiving a readout signal from each of the plurality of readout resonators, thereby receiving a plurality of readout signals, and detecting background radiation incident on one or more qubits of the plurality of qubits based on the plurality of readout signals.

The foregoing apparatus and method embodiments may be implemented with any suitable combination of aspects, features, and acts described above or in further detail below. These and other aspects, embodiments, and features of the present teachings can be more fully understood from the following description in conjunction with the accompanying drawings.

### BRIEF DESCRIPTION OF DRAWINGS

Various aspects and embodiments will be described with reference to the following figures. It should be appreciated that the figures are not necessarily drawn to scale. In the drawings, each identical or nearly identical component that is illustrated in various figures is represented by a like numeral. For purposes of clarity, not every component may be labeled in every drawing.

FIG. 1A depicts an array of superconducting qubits, according to some embodiments;

FIG. 1B depicts an illustrative resonator and qubit pair, according to some embodiments;

FIGS. 2A-2B depict the response of a readout resonator during normal operation and subsequent to an impact event, according to some embodiments;

FIG. 3 depicts a system suitable for practicing aspects of the present disclosure, according to some embodiments; and

FIGS. 4A-4B depict examples of how logical information may be extracted from an array of qubits subsequent to detecting an impact event amongst the array of qubits, according to some embodiments.

### DETAILED DESCRIPTION

Several different types of qubits have been successfully demonstrated in the laboratory. However, the lifetime of the quantum states of these systems before information is lost due to decoherence, or to other quantum noise, may be on the order of ˜100 μs. Even if qubit lifetimes improve, it may be important to provide error correction techniques in quantum computing that enable reliable storage and retrieval of information stored in a quantum system. In general, quantum error correction may include detecting when a qubit's state has decohered or has otherwise changed due to uncontrolled quantum effects, and performing one or more operations on the qubit to correct the error.

Some quantum error correction techniques may include operating a quantum system exhibiting more than two distinct states in which a single logical qubit is encoded. If the logical qubit information is properly encoded in the quantum system, it may be protected from decoherence of the full system state. In some cases, a number of qubits are together treated as a single logical qubit to make error correction more reliable since an error that occurs in one qubit may not be expected to simultaneously also occur in other qubits.

One approach to error correction, for instance, uses a two-dimensional array of physical qubits as a single “logical” qubit. If error rates on each of the physical qubits are sufficiently small (e.g., ˜0.1% per round of error correction), the quantum information encoded in the array can be protected through suitable error correction operations on the qubits. However, even relatively infrequent correlated errors across multiple qubits can result in problems because error correction techniques rely on the correction of uncorrelated errors occurring in a qubit. For example, if errors are produced in multiple qubits around the same time that have some kind of correlated property (e.g., multiple qubits all gain the same amount of energy, or decohere), at least some error correction techniques may not be able to effectively correct for such errors.

The inventors have recognized and appreciated that one source of correlated errors across multiple qubits may be background radiation, such as background gamma or cosmic ray radiation (e.g., muons). When background radiation is incident on a qubit, they may cause the qubit to decohere. Moreover, it is likely that such impacts will occur over several qubits at the same time, which could lead to correlated decoherence over those qubits.

For instance, a superconducting charge qubit relies on the condensation of conduction elections into a superconducting condensate, which then possesses discrete energy states. A gamma ray impact may, however, deposit around 100 keV into the device substrate, which is roughly a billion times the energy of a single excitation of the charge qubit. This energy may result in the creation of millions of quasiparticles, thereby inducing errors in a number of qubits and suppressing the qubit lifetimes by several milliseconds following the impact. These events can produce correlated errors because a gamma ray impact would typically be expected to deposit energy over an area containing multiple qubits.

These challenges could potentially be addressed by shielding the qubits from radiation, and/or by adding additional particle detectors to indicate when such impacts occur. However, shielding is unlikely to eliminate all sources of background due to high energy cosmic rays, spallation events, and contamination inside the shield, and both approaches require additional hardware and infrastructure to build and maintain.

The inventors have recognized and appreciated techniques to detect when background radiation has impacted a qubit without the need for additional hardware. In particular, the readout hardware used to read the state of a qubit can be used to detect when an impact has occurred. Readouts from the impacted qubits can then be ignored during error correction, and those qubits reset for subsequent operations.

The techniques described herein utilize the recognition that the readout signals that are produced from a qubit can be used to detect whether the qubit has suffered an impact. In some embodiments, detection of impacts may be achieved using modified readout resonators coupled to each qubit, as described further below. The system can accordingly be configured to detect which qubits have been impacted by background radiation by looking at the signals produced from the modified readout resonators. In addition, the techniques described herein further utilize the recognition that correlated errors resulting from radiation impacts on qubits are expected to occur in spatially clustered groups of qubits, and are expected to occur only in groups and not to single qubits in an array (although this may not be true in every instance of a radiation impact).

In some embodiments, a system may comprise an array of qubits that are each coupled to respective readout resonators. The system may be configured to detect, based on readout signals from the readout resonators, which of the qubits in the array have been impacted by background radiation by identifying a spatial cluster of the qubits whose respective readout resonator signals show an indication of an impact.

In some embodiments, a system may comprise an array of qubits that are each coupled to respective readout resonators, and the readout resonators may be formed from, or may comprise, a superconductor with a high kinetic inductance. Kinetic inductance is a portion of the total inductance of a material, and arises from the kinetic energy stored in the motion of charge carriers. Readout resonators with a high kinetic inductance are referred to herein as “microwave kinetic inductance detectors” (MKIDs), although it will be appreciated that these structures may be used as standard readout resonators in addition to as an impact detector as described below.

When a particle impact occurs, some of the energy of the impact will deposit energy in the resonator. This may in turn produce quasiparticles in the resonator. In an MKID, the increased quasiparticle density also causes the kinetic inductance of the resonator to increase, which can be detected by monitoring the resonator frequency. As a result, the MKID can be used to detect a particle impact. At other times during normal operation, the MKID may behave as a conventional readout resonator by producing readout signals from a qubit coupled to the resonator.

The kinetic inductance of a readout resonator may be measured in any suitable manner. The kinetic inductance is a property of the superconducting material(s) comprised by the readout resonator, and varies by temperature. At temperatures substantially below the superconducting transition of a superconducting material, the kinetic inductance is expected to be constant, or substantially constant. Closer to the superconducting transition temperature T_{c} (e.g., at above half T_{c}), the kinetic inductance may increase from this constant value. As such, kinetic inductances of a superconducting material referred to herein relate to the kinetic inductance as measured substantially below the superconducting transition temperature of the superconducting material, such as below 0.6 T_{c}, below 0.5 T_{c}, below 0.4 T_{c}, below 0.3 T_{c}, or below 0.2 T_{c}.

According to some embodiments, the kinetic inductance of a superconducting material may be described with reference to the kinetic inductance fraction, which is the portion of the total inductance of the superconducting material that is due to kinetic inductance. According to some embodiments, a “high kinetic inductance” material may refer to a material for which the kinetic inductance fraction is equal to or greater than 3%, 5%, 8%, 10%, or 15%. According to some embodiments, a “high kinetic inductance” material may refer to a material for which the kinetic inductance fraction is equal to or less than 30%, 20%, 15%, 10%, or 5%. Combinations of these ranges are also possible (e.g., a high kinetic inductance superconducting material may refer to a superconducting material for which the kinetic inductance fraction is equal to or greater than 3% and less than or equal to 10%).

As used herein, a “high kinetic inductance readout resonator” refers to a readout resonator comprising one or more high kinetic inductance materials. For instance, a high kinetic inductance readout resonator may be a readout resonator that comprises, or that is formed from, a high kinetic inductance superconducting material such as niobium titanium nitride and/or granular aluminum.

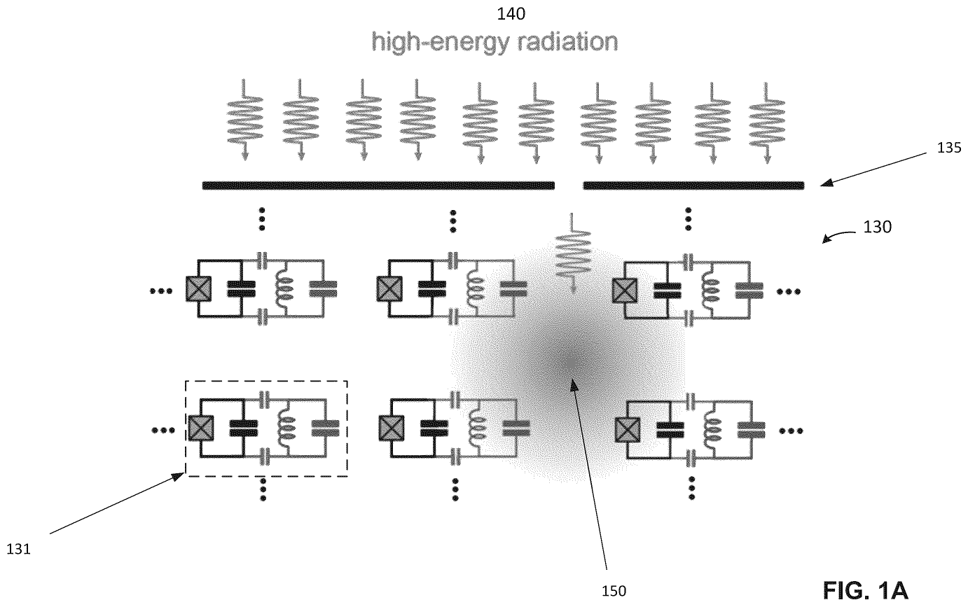

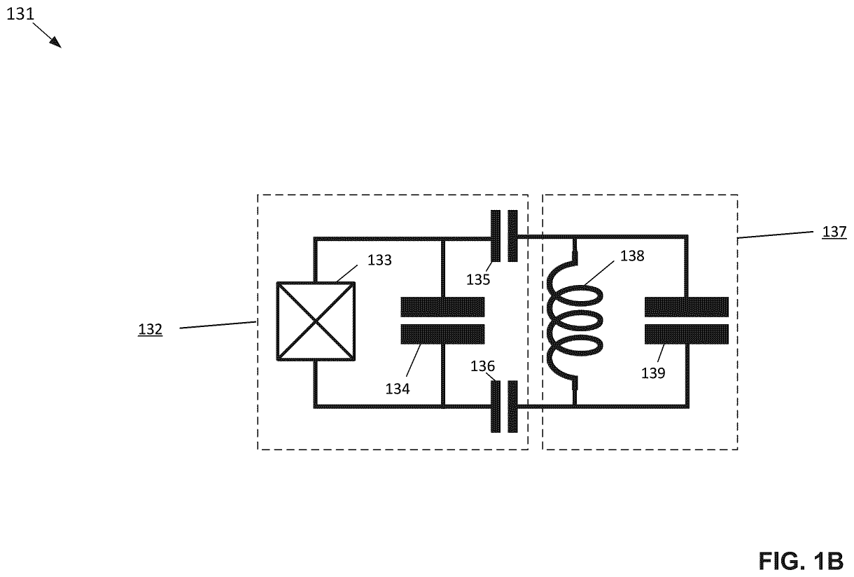

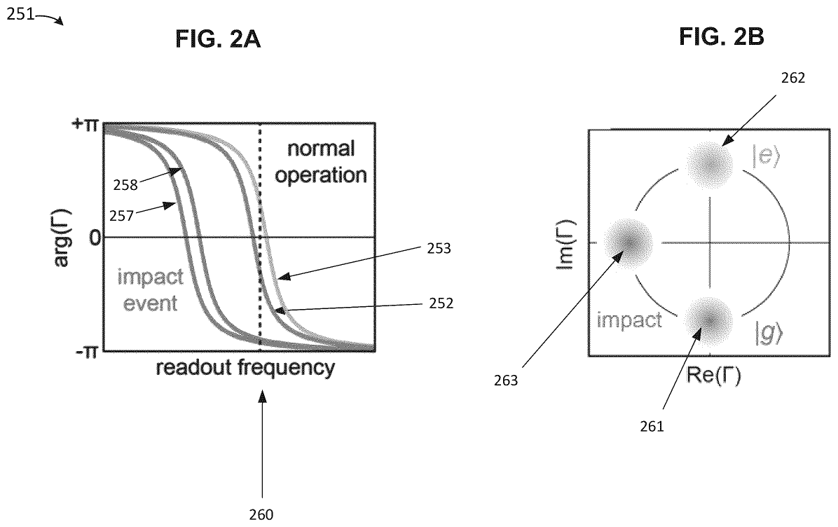

As an example of how an MKID readout resonator may function in a superconducting quantum processor, FIGS. 1A-1B and 2A-2B relate to an illustrative quantum processor that may be operated as follows.

In the example of FIG. 1A, an array of superconducting qubits 130 is depicted, wherein each of the superconducting qubits in the array 130 is coupled to a respective readout resonator. Each of the qubits and resonator pairs in the array (of which qubit-resonator pair 131 is one example) includes a charge qubit (depicted by a capacitor coupled to a Josephson junction on the left of the unit) coupled to a readout resonator (depicted by an inductor coupled to a capacitor on the right of the unit). Even in the presence of a passive shield 135, which may extend entirely around the array 130, occasional background radiation may be incident on the qubit array, causing an impact event 150. The region in which energy is deposited by impact 150 is depicted in FIG. 1A as a shaded area.

The illustrative qubit-resonator pair 131 is shown in FIG. 1B in further detail, and includes qubit 132 and resonator 137. In the example of FIG. 1B, the qubit 132 includes a transmon qubit formed from a Josephson junction 133 and capacitance 134. The qubit 132 is capacitively coupled to resonator 137, represented as inductor 138 with shunt capacitance 139. While the illustrative qubit 132 is depicted as a transmon, it will be appreciated that the techniques described herein may be utilized with any type of superconducting qubit, including other types of charge qubits.

According to some embodiments, resonator 137 may comprise a superconducting resonator. For example, resonator 137 may be a waveguide resonator (e.g., a coplanar waveguide) formed from an aluminum film with a meandered resonator section on a sapphire substrate. In some embodiments, resonator 137 may comprise a non-planar waveguide (e.g., a 3D cavity waveguide).

In some embodiments, the resonator 137 may comprise a non-planar waveguide (e.g., a superconducting cavity) and qubit 132 may be arranged within the waveguide (e.g., deposited on a substrate within the waveguide). As one example, resonator 137 may comprise a resonant structure arranged within a superconducting cavity (e.g., formed from aluminum or copper) and suspended over an opening within the cavity, with ends of the resonant structure being supported by the cavity.

In some embodiments, the resonator 137 may comprise a resonant structure comprising a superconductor such as aluminum, granular aluminum, or niobium titanium nitride, which may be in some cases deposited over a dielectric substrate such as sapphire or silicon. In the case of materials such as granular aluminum or niobium titanium, the resulting resonator may be an MKID resonator. Alternatively, materials such as aluminum may be arranged to form an MKID resonator if the dimensions of the resonating structure are chosen suitably.

In some embodiments, the qubit 131 may be arranged within the resonator 137 (e.g., formed on a substrate within a resonant structure). As one example, resonator 137 may comprise a resonant structure arranged within a superconducting cavity and suspended over an opening within the cavity, with ends of the resonant structure being supported by the cavity, and may comprise an additional substrate suspended over an opening within the cavity on which the qubit is formed. Examples of the above-described resonators comprising a resonant structure arranged within a superconducting cavity and suspended over an opening within the cavity, both with and without qubits arranged within the cavity, are described in PCT Patent Publication WO2022/178087, which is hereby incorporated by reference in its entirety.

Irrespective of how it is implemented, when operating the resonator 137 as a readout resonator, the resonator is arranged such that its resonant frequency (e.g., ˜GHz) is far from the transition frequency of the qubit 132 (e.g., dispersively coupled). The coupling between the qubit and resonator means that there is a shift in the resonator frequency that is dependent on the state of the qubit. This shift is small compared with the resonant frequency of the resonator (e.g., ˜MHz). As a result, sending a tone to the resonator 137 near the resonant frequency will be reflected by the resonator and the form of the reflected tone (also referred to herein as the “readout signal”) can be analyzed to determine the state of the qubit. In this manner, the state of a qubit can be probed non-destructively by sending probe tones to a readout resonator that is dispersively coupled to the qubit.

However, as described above, deposition of energy from an impact event, such as a gamma, beta or muon particle incident on a plurality of qubits, may produce correlated errors in those qubits. When this happens, the resonator frequency is also effectively shifted down due the increased quasiparticle density within the resonator. As a result, the resonator can no longer be used for qubit readout during the impact, and the associated qubit's state is affected until the energy deposited by the particle impact has sufficiently dissipated.

FIG. 2A depicts the differences between normal operation of the readout resonator in the absence of a particle impact, and operation of the readout resonator immediately subsequent to a particle impact. Plot 251 shows the relationship between the readout frequency and reflection coefficient F for a readout resonator during normal operation (252 and 253) versus immediately subsequent to an impact event (257 and 258). The reflection coefficient may be measured from a reflected tone (the readout signal) as described above. In the absence of radiation, the frequency of the resonator depends on whether the qubit is in the ground state (252) or the excited state (253). This shift was described above as the manner in which dispersive readout of a resonator can identify the state of a coupled qubit. In the event of an impact, however, both curves are shifted strongly towards lower frequencies, with the frequency of the resonator now having a different dependency on the qubit being in the ground state (257) or in the excited state (258).

According to the techniques described herein, a readout resonator may be operated by arranging a microwave readout tone applied to the resonator at a frequency 260 (represented by the dotted line in FIG. 2A). As a result, a qubit operating normally in the ground or excited state can be distinguished from a qubit subsequent to an impact event, where the reflection coefficient is much lower than for either the ground or excited states in normal operation. This configuration is also represented in FIG. 2B, which shows how the real and imaginary components of the reflection coefficient distinguish between the ground (261) and excited (262) states in normal operation, and an impact event (263). In this manner, by measuring the reflection coefficient of a readout signal, an impact event may be identified because the readout signal produced subsequent to an impact event can be distinguished from readout signals that would be produced if the qubit was in either its ground or excited state.

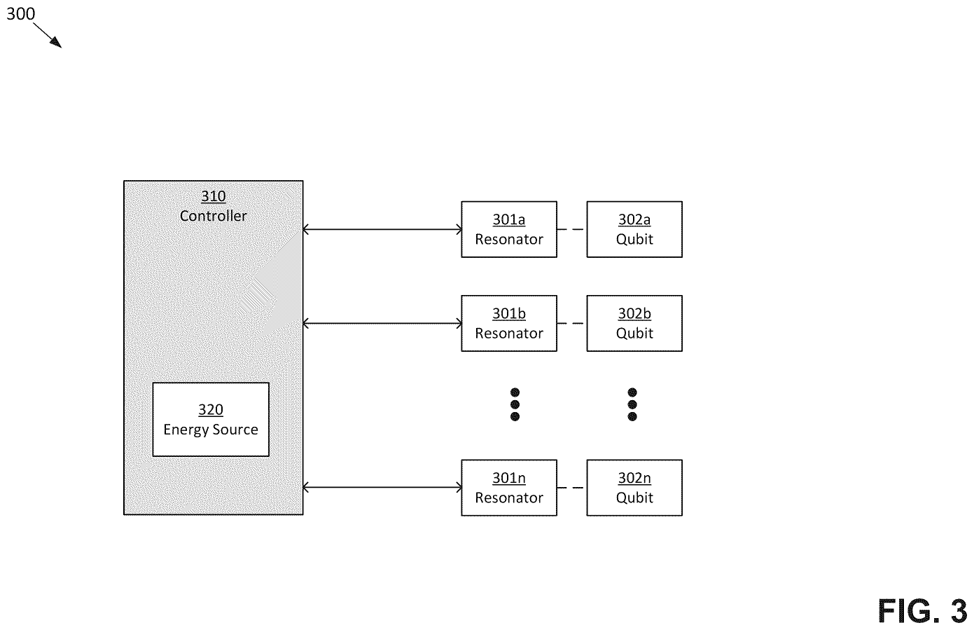

FIG. 3 depicts a system suitable for practicing aspects of the present disclosure, according to some embodiments. In the example of FIG. 3, system 300 comprises a plurality of qubits 302 each coupled to a respective resonator 301. The qubits 302 may be arranged in any suitable physical arrangement, including any type of array (e.g., grid). In some embodiments, the resonators 301 and qubits 302 may be implemented as the illustrative resonator-qubit pair 131 shown in FIG. 1B, various implementations of which are described above.

In the example of FIG. 3, controller 310 is configured at least to operate an energy source 320 to direct energy to any number of the resonators 301, and to receive reflected energy from each resonator representing a readout signal from that resonator. As described above, the readout signal may be analyzed by the controller to determine whether the qubit coupled to the resonator is in its ground state, its excited state, or whether an impact event may be affecting operation of the qubit. According to some embodiments, the energy directed by the energy source 320 may include an electromagnetic pulse (e.g., microwave pulse) directed along a waveguide to the resonator.

In the example of FIG. 3 controller 310 is configured to detect, based on readout signals received from the resonators 301, whether background radiation was incident on any of the qubits coupled to the respective resonators 301. For instance, when the readout signals for a qubit 302 exhibits a reflection coefficient as shown in FIG. 2B (location 263), the controller 310 may determine that this qubit experienced an impact event, and may take action based on such a determination (e.g., excluding this qubit from calculations). According to some embodiments, impact events can be detected as they occur and qubits near the impact site can be temporarily ignored.

In some embodiments, the controller 310 may determine whether a qubit experienced an impact event based both on the value of the reflection coefficient for a readout signal received from an associated resonator, but also based on the relative spatial locations of all the qubits that produced readout signals within a given time window that are indicative of an impact event. As described above, impact events are expected to be correlated in both space and time, and so identifying an impact event may be based not only on the readout signals for qubits but also the relative spatial location of those qubits. For instance, two qubits with coupled resonators that produce readout signals indicating an impact event that are far from one another may not be identified as an impact event because more than two qubits would be expected to be affected by an impact event, and because any such qubits would be expected to be near to one another. Alternatively, ten qubits with coupled resonators that produce readout signals indicating an impact event that are arranged in a cluster may be identified as an impact event.

According to some embodiments, controller 310 may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semi-custom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format. According to some embodiments, controller 310 may comprise a Field Programmable Gate Array (FPGA) coupled to a general purpose processor, wherein the FPGA is loaded with instructions to send and receive pulses to/from the resonators 301.

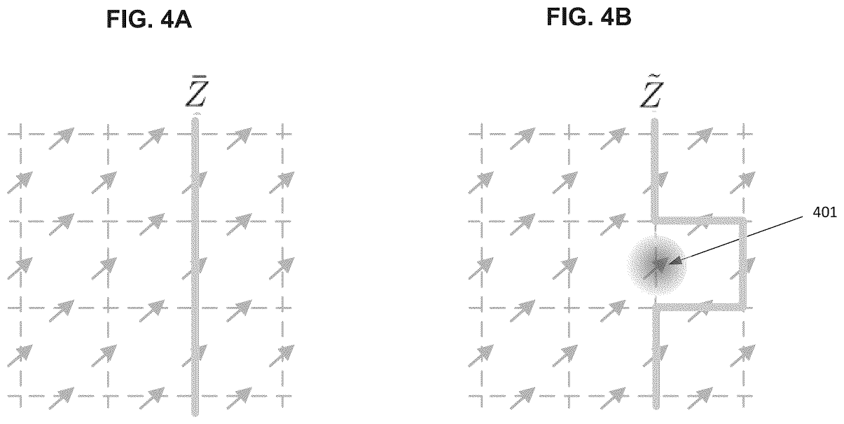

FIGS. 4A-4B depict examples of how logical information may be extracted from an array of qubits subsequent to detecting an impact event amongst the array of qubits. In the examples of FIGS. 4A-4B, qubits are represented by arrows, with the dashed lines in the grid representing couplings between qubits. Associated resonators are not shown.

In the example of FIG. 4A, logical information may be encoded in a path labeled Z, which passes from the top of the array to the bottom through three qubits. If an impact occurs, this logical information can be routed around any qubits that need to be excluded (e.g., as a result of detecting an impact within these qubits, as discussed above). This re-routing is illustrated in FIG. 4B, wherein a qubit 401 is excluded due to an impact, but a new path 2 can be selected to maintain the logical information stored in the array.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Further, though advantages of the present invention are indicated, it should be appreciated that not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

Various aspects of the present invention may be used alone, in combination, or in a variety of arrangements not specifically described in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value. The term “substantially equal” may be used to refer to values that are within ±20% of one another in some embodiments, within ±10% of one another in some embodiments, within ±5% of one another in some embodiments, and yet within ±2% of one another in some embodiments.

The term “substantially” may be used to refer to values that are within ±20% of a comparative measure in some embodiments, within ±10% in some embodiments, within ±5% in some embodiments, and yet within ±2% in some embodiments. For example, a first direction that is “substantially” perpendicular to a second direction may refer to a first direction that is within ±20% of making a 90° angle with the second direction in some embodiments, within ±10% of making a 90° angle with the second direction in some embodiments, within ±5% of making a 90° angle with the second direction in some embodiments, and yet within ±2% of making a 90° angle with the second direction in some embodiments.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A circuit quantum electrodynamics system comprising:
a plurality of qubits;
a plurality of readout resonators, wherein each qubit of the plurality of qubits is coupled to one of the plurality of readout resonators;
at least one controller; and
at least one computer readable medium storing instructions that, when executed by the at least one controller, perform a method comprising:
receiving a readout signal from each of the plurality of readout resonators, thereby receiving a plurality of readout signals; and
detecting background radiation incident on one or more qubits of the plurality of qubits based on the plurality of readout signals and based on the relative spatial locations of the plurality of qubits.

2. The circuit quantum electrodynamics system of claim 1, wherein detecting background radiation incident on the one or more qubits comprises determining, for each of the plurality of qubits, whether the qubit is in its ground state, in its excited state, or in a third state as a result of the incident background radiation.

3. The circuit quantum electrodynamics system of claim 1, wherein detecting background radiation incident on the one or more qubits comprises determining whether or not the one or more qubits are spatially clustered.

4. The circuit quantum electrodynamics system of claim 1, wherein the plurality of readout resonators comprise one or more superconducting cavity resonators.

5. The circuit quantum electrodynamics system of claim 1, wherein the plurality of qubits comprise one or more charge qubits.

6. The circuit quantum electrodynamics system of claim 5, wherein the plurality of qubits comprise one or more transmon qubits.

7. The circuit quantum electrodynamics system of claim 1, wherein the instructions are further configured to operate one or more electromagnetic energy sources to direct an electromagnetic signal onto each of the plurality of readout resonators, thereby producing respective readout signals from the plurality of readout resonators as reflected electromagnetic signals.

8. The circuit quantum electrodynamics system of claim 1, wherein detecting the background radiation incident on the one or more qubits of the plurality of qubits comprises determining a reflection coefficient of each of the plurality of readout signals.

9. The circuit quantum electrodynamics system of claim 8, wherein detecting the background radiation incident on the one or more qubits of the plurality of qubits comprises determining whether the reflection coefficient of each of the plurality of readout signals is below a threshold.

10. The circuit quantum electrodynamics system of claim 9, wherein detecting the background radiation incident on the one or more qubits of the plurality of qubits comprises identifying qubits with associated readout resonators that produced readout signals that have a reflection coefficient below the threshold, and which are spatially proximate to one another.

11. A circuit quantum electrodynamics system comprising:
a plurality of qubits;
a plurality of high kinetic inductance readout resonators, wherein each qubit of the plurality of qubits is coupled to one of the plurality of readout resonators;
at least one controller; and
at least one computer readable medium storing instructions that, when executed by the at least one controller, perform a method comprising:
receiving a readout signal from each of the plurality of readout resonators, thereby receiving a plurality of readout signals; and
detecting background radiation incident on one or more qubits of the plurality of qubits based on the plurality of readout signals.

12. The circuit quantum electrodynamics system of claim 11, wherein detecting background radiation incident on the one or more qubits comprises determining, for each of the plurality of qubits, whether the qubit is in its ground state, in its excited state, or in a third state as a result of the incident background radiation.

13. The circuit quantum electrodynamics system of claim 11, wherein the high kinetic inductance readout resonators comprise titanium nitride and/or granular aluminum.

14. The circuit quantum electrodynamics system of claim 11, wherein the plurality of high kinetic inductance readout resonators comprise one or more superconducting cavity resonators.

15. The circuit quantum electrodynamics system of claim 14, wherein the one or more high kinetic inductance superconducting cavity resonators are formed from titanium nitride and/or granular aluminum.

16. The circuit quantum electrodynamics system of claim 14, wherein the one or more high kinetic inductance superconducting cavity resonators are formed from a material with a kinetic inductance fraction equal to or greater than 3% and less than or equal to 10% when measured below 0.5 Tc, where Tc is the superconducting transition temperature of the one or more high kinetic inductance superconducting cavity resonators.

17. The circuit quantum electrodynamics system of claim 11, wherein detecting background radiation incident on the one or more qubits comprises determining, for each of the plurality of qubits, whether the qubit is in its ground state, in its excited state, or in a third state as a result of the incident background radiation.

18. The circuit quantum electrodynamics system of claim 11, wherein detecting background radiation incident on the one or more qubits comprises determining whether or not the one or more qubits are spatially clustered.

19. The circuit quantum electrodynamics system of claim 11, wherein the plurality of readout resonators comprise one or more superconducting cavity resonators.

20. The circuit quantum electrodynamics system of claim 11, wherein the plurality of qubits comprise one or more charge qubits.

21. The circuit quantum electrodynamics system of claim 20, wherein the plurality of qubits comprise one or more transmon qubits.

22. The circuit quantum electrodynamics system of claim 11, wherein the instructions are further configured to operate one or more electromagnetic energy sources to direct an electromagnetic signal onto each of the plurality of readout resonators, thereby producing respective readout signals from the plurality of readout resonators as reflected electromagnetic signals.

23. The circuit quantum electrodynamics system of claim 11, wherein detecting the background radiation incident on the one or more qubits of the plurality of qubits comprises determining a reflection coefficient of each of the plurality of readout signals.

24. The circuit quantum electrodynamics system of claim 23, wherein detecting the background radiation incident on the one or more qubits of the plurality of qubits comprises determining whether the reflection coefficient of each of the plurality of readout signals is below a threshold.

25. The circuit quantum electrodynamics system of claim 24, wherein detecting the background radiation incident on the one or more qubits of the plurality of qubits comprises identifying qubits with associated readout resonators that produced readout signals that have a reflection coefficient below the threshold, and which are spatially proximate to one another.
